(19) United States
(12) Patent Application Publication
(10) Pub. No.: US 2026/0243579 A1
(43) Pub. Date: Aug. 20, 2026

(54) COMPUTER ENHANCED AUDITORY NAVIGATION USING HEADPHONES

(71) Applicant: INTERNATIONAL BUSINESS MACHINES CORPORATION, ARMONK, NY (US)

(72) Inventor: Tyler Waite, Lake Washington, WA (US)

(21) Appl. No.: 19/055,037

(22) Filed: Feb. 17, 2025

(51) Int. Cl. G01C 21/36

(52) U.S. Cl. CPC G01C 21/3629; G01C 21/3608

(57) ABSTRACT

Enhancement of auditory navigation instructions can include detecting and receiving, at an AI (Artificial Intelligence) enhanced device which includes GPS (Global Positioning System) location data, navigation instructions. The receiving of the navigation instructions can be either from auditory capture by the AI enhanced device of an announcement at a location, or a data update from a monitoring system electronically received by the AI enhanced device. Using the AI enhanced device, one or more keywords can be detected in the navigation instructions. In response to the detecting of the one or more keywords by the AI enhanced device, the AI enhanced device can output an acoustically enhanced version of the navigation instructions to audio headphones of the user.

### BACKGROUND

The present disclosure relates to computer enhanced auditory navigation instructions using headphones, and more specifically, computer enhanced auditory navigation instructions using headphones using AI (Artificial Intelligence).

In one example, people can have trouble distinguishing auditory information they need from an environment to assist with navigation. For example, people can have vision impairments which can exacerbate their need to distinguish auditory information from the environment to assist with navigation. In another example, an environment can include an airport or a train station or any venue including navigation from one point to another. In another example, people can have a condition such as misophonia and can wear noise canceling headphones to block out unwanted noise from the environment.

However, there may be environmental sounds, announcements, or instruction that people need to hear such as announcements over speakers in airport terminals, or stops on the subway or bus, or beeps and auditory cues to cross the street. Such instructions can be missed by a person navigating through a venue or on a trip to a destination.

The present disclosure recognizes the shortcomings and problems associated with

In an aspect according to the present invention, a computer-implemented method for enhancement of auditory navigation instructions includes detecting and receiving, at an AI (Artificial Intelligence) enhanced device which includes GPS (Global Positioning System) location data, navigation instructions. The receiving of the navigation instructions is either from auditory capture by the AI enhanced device of an announcement at a location, or a data update from a monitoring system electronically received by the AI enhanced device. The method includes detecting, using the AI enhanced device, one or more keywords in the navigation instruction. And the method includes, in response to the detecting of the one or more keywords by the AI enhanced device, the AI enhanced device outputting an acoustically enhanced version of the navigation instructions to audio headphones of a user.

In a related aspect, the keywords include navigation cues for the user.

In a related aspect, the keywords include navigation cues related to a travel itinerary of the user which includes a location of the user and a destination.

In a related aspect, the enhanced version of the navigation instructions includes acoustically cleaning the instructions.

In a related aspect, the method further includes determining, using an AI enhanced device, when the user is at a location where auditory navigation cues or messages are used.

In a related aspect, the data update from the monitoring system is from a transit system or transit monitoring software application.

In a related aspect, the method further including reducing environmental noise from a location of the user, the reducing of the environmental noise including the audio headphone suppressing the environmental noise.

In a related aspect, the method further including reducing environmental noise from a location of the user, the reducing of the environmental noise including the AI enhanced device suppressing the environmental noise.

In a related aspect, the method further including replaying the instructions, in response to the AI enhanced device receiving a command from the user initiating the replaying of the instructions.

In a related aspect, the method further including receiving the data update from a travel or transit monitoring software application, and the AI enhanced device listening for the one or more keywords in the navigation instructions as an audio broadcast at a location of the user. The method further includes the AI enhanced device deriving the one or more keywords from the data update, and the detecting of the one or more keywords including detecting the one or more keywords in the navigation instructions in the audio broadcast at the location of the user. The method further including the auditory enhanced version of the navigation instructions including acoustically cleaning the instructions.

In another embodiment according to the present invention, a computer system for enhancement of auditory navigation instructions includes, a processor set, a computer-readable storage medium, and program instructions stored on the computer-readable storage medium to cause the processor set to perform operations including: detecting and receiving, at an AI enhanced device which includes GPS (Global Positioning System) location data, navigation instructions, the receiving of the navigation instructions either from auditory capture by the AI enhanced device of an announcement at a location, or a data update from a monitoring system electronically received by the AI enhanced device; detecting, using the AI enhanced device, one or more keywords in the navigation instructions; and in response to the detecting of the one or more keywords by the AI enhanced device, the AI enhanced device outputting an acoustically enhanced version of the navigation instructions to audio headphones of the user.

In a related aspect, the keywords include navigation cues for the user.

In a related aspect, the keywords include navigation cues related to a travel itinerary of the user which includes a location of the user and a destination.

In a related aspect, the enhanced version of the navigation instructions includes acoustically cleaning the instructions.

In a related aspect, the system further includes determining, using an AI enhanced device, when the user is at a location where auditory navigation cues or messages are used.

In a related aspect, the data update from the monitoring system is from a transit system or transit monitoring software application.

In a related aspect, the system further includes reducing environmental noise from a location of the user, the reducing of the environmental noise including the audio headphone suppressing the environmental noise.

In a related aspect, the system further includes reducing environmental noise from a location of the user, the reducing of the environmental noise including the AI enhanced device suppressing the environmental noise.

In a related aspect, the system further includes replaying the instructions, in response to the AI enhanced device receiving a command from the user initiating the replaying of the instructions.

In another embodiment according to the present invention a computer program product for enhancement of auditory navigation instructions includes a computer readable storage medium, and program instructions stored on the computer readable storage medium to perform operations comprising: detecting and receiving, at an AI enhanced device which includes GPS (Global Positioning System) location data, navigation instructions, the receiving of the navigation instructions either from auditory capture by the AI enhanced device of an announcement at a location, or a data update from a monitoring system electronically received by the AI enhanced device; detecting, using the AI enhanced device, one or more keywords in the navigation instructions; and in response to the detecting of the one or more keywords by the AI enhanced device, the AI enhanced device outputting an auditory enhanced version of the navigation instructions to audio headphones of the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a functional block diagram of an earbud as a headphone device for use in enhancement of auditory navigation instruction and used by a user at a location.

FIG. 2 is a schematic block diagram of a system for enhancement of auditory navigation instructions including the location shown in FIG. 1.

FIG. 3 is a flow chart depicting a method for enhancement of auditory navigation instructions.

FIG. 4 is a schematic block diagram depicting a computer system according to an embodiment of the disclosure, which includes cloud computing components and functions, and which can cooperate with the one or more apparatuses, systems, and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a user can be a customer, an individual, or a group of individuals, or a company or an organization.

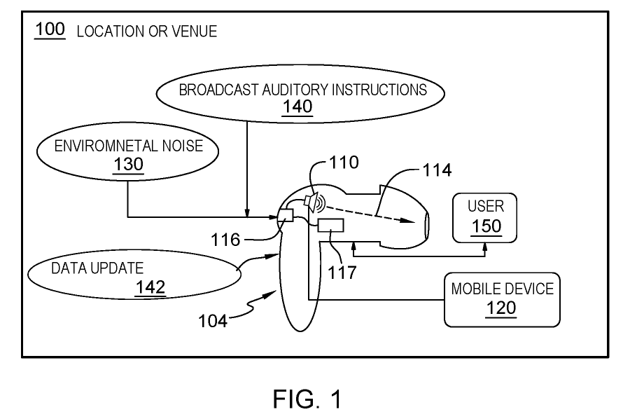

Referring to FIG. 1, headphones embodied as an AI enhanced earbud, also referred to herein as an earbud 104 can be an integrated Bluetooth® earbud with a microphone 116. The earbud can include a sound dampening feature 117 which can help reduce environmental noise that can be found in busy environments like terminals, train stations, and busstops. The earbud 104 can be used by a user 150 at a location or venue 100. The earbud 104 includes the microphone 116 and a speaker 110 which can generate an audio output 114. The microphone 116 receives audio input at the location including environmental noise 130 and broadcast auditory instruction 140. A mobile device 120 can communicate with the earbud 104 using wired or wireless technology, to provide audio for the user from an application stored on the mobile device.

Embodiments of the present disclosure can include combining blue tooth headphones with noise dampening earbuds and AI (Artificial Intelligence) speech recognition software to listen for navigation related announcement in the user’s environment, such as location 100.

In one embodiment, when navigation related announcements are detected, AI can acoustically enhance announcements and send the information to a Bluetooth® speaker so that the user does not miss the announcement. Thus, AI speech recognition can detect and enhance the acoustic quality of navigation related messages from the environment.

For example, challenges caused by lack of information heard by a person can include: difficulties to identify a bus stop depending on the information from transportation personnel or other travelers; lack of indications on crossroads and bus stops; information related to bus and route number; information related to unexpected construction or change of layout; difficulty to ask for assistance or directions during rush hours; and inability to identify a restroom location. In other examples, challenges caused by lack of information heard by a person can be caused by the environment having a high noise level. Such environments can include: train stations; shopping malls; public parks and airports which can be too spacious to navigate easily. Other challenges in a venue or location that can impact a person hearing information can include too many overlapping sounds which can hinder identifying locations within a venue; and announcements in a venue for updates about trains, busses, flights and other information.

Embodiments of the present disclosure, for example, can combine Bluetooth® headphones with noise dampening earbuds and AI speech recognition software on a mobile device connected to the headphone to listen for navigation related announcement in a user’s environment. In one example, a method can use AI speech recognition to detect and enhance the acoustic quality of navigation related messages in the environment. In one example, a method according to the present disclosure can use AI speech recognition to detect and enhance the acoustic quality of navigation related messages from the environment.

In one embodiment according to the present disclosure, a user can put in AI enhanced earbuds into one or more of their ears. The AI can use GPS (Global Positioning System) from a smartphone to try and determine if user is in an area where auditory navigation cues might be provided, such as at a crosswalk, or on a bus or commuter train, or in an airport. AI Speech recognition on the smartphone can listen for keywords commonly used in these situations such as “Gate” or “Next Stop” or “Wait”. When an environmental navigation cue is detected, the AI recognition relays an enhanced and acoustically cleaned up version of the message to the blue tooth earbuds for the user to hear.

In another example, similarly to the previous example, however, a user can also connect to a travel application on a smartphone. The travel application can transmit information about a gate or a stop the user wants the AI speech recognition to listen for so that the travel application doesn’t relay an enhanced version of non-relevant environmental navigation announcements.

Embodiments of the present disclosure can receive information from a travel application about information such as gate information at an airport or terminal or listen for a broadcast of such information at a location such as an airport. Embodiments can also extract data that AI should listen for to reduce distractions for a user with unnecessary information. Embodiments can also use data directly from a travel application on a smart phone. Travel application such as those for major airlines, are updated when gate locations change. Embodiments of the present invention can combine wireless headphones with a sound dampening feature such as a sound dampening loop that allows ambient sound to continue to be heard by the user while the headphone speaker is used to enhance and clarify important environmental announcements. By pulling data from the travel application an AI system can update with respect to what to listen for without a user needing to define all possible speech patterns they may need.

In embodiments of the present disclosure, an AI system can reside on a mobile device that an earbud wirelessly connects with. Natural Language Processing (NLP) and speech recognition can be used to identify announcements related to a user’s travel plans. An AI system can include a feature that allows the user to replay an AI announcement. In embodiments an AI system can listen for announcements relayed via a public announcement system such as boarding announcements, or when a next stop is the one a user is waiting for to exit a bus or subway.

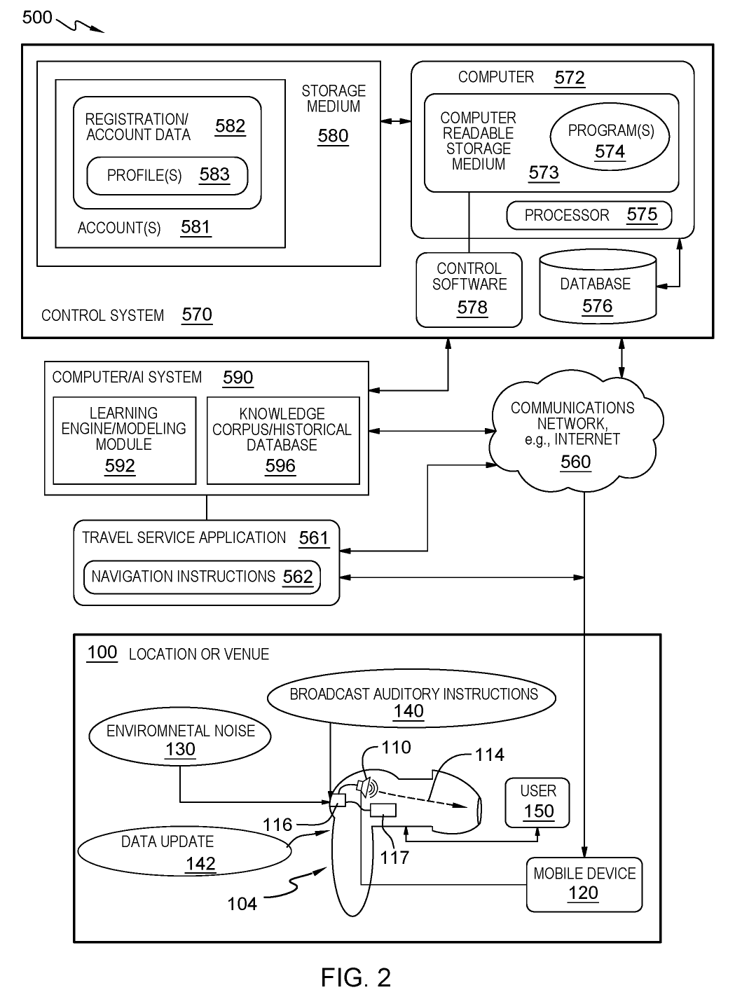

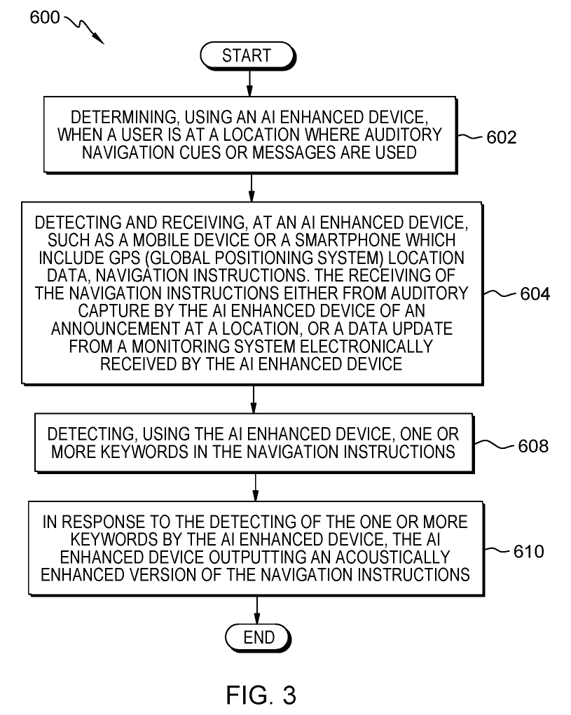

Referring to FIGS. 1, 2 and 3, in one embodiment according to the present disclosure, a computer-implemented method 600 can be used with a system 500 (shown in FIG. 2) for enhancement of auditory navigation instructions which can use Artificial Intelligence (AI) and can include determining, using an AI enhanced device, when a user is at a location where auditory navigation cues or messages are used, as in operation 602.

The method 600 includes detecting and receiving, at an AI enhanced device, such as a mobile device 120 or smartphone which include GPS (Global Positioning System) location data, navigation instructions 562, as in operation 604. The receiving of the navigation instructions either from auditory capture by the AI enhanced device (e.g., the earbud 104) of an announcement at a location 100, which can be broadcast auditory instructions 140 such as navigation instructions. Or, the navigation instructions can be a data update 142 from a monitoring system electronically received by an AI enhanced device embodied as the earbud 104, as in operation 604. The monitoring system can be a travel service application 561 which can be an application on the mobile device or a service communicating with the mobile device. The travel service application can generate navigation instructions 562 received by the mobile device. The microphone 116 can receive as input the broadcast auditory instruction 140 and receive environmental noise 130. The speaker 110 outputs the received input to the user 150.

The method 600 includes detecting, using the AI enhanced device, one or more keywords in the navigation instructions, as in operation 608. The keywords can include navigation cues or messages being received at the earbud from the microphone and communicated to the mobile device and/or received at the smartphone from the travel application.

The method 600 includes in response to the detecting of the one or more keywords by the AI enhanced device, the AI enhanced device outputting an acoustically enhanced version of the navigation instructions, as in operation 610. The acoustically enhanced version of the navigation instructions can include the one or more keywords and the acoustically cleaned version of the navigation instructions or cues or messages received by audio headphones, embodied as one or more earbuds 104, or a headset used by the user.

In embodiments of the method 600 the keywords can include navigation cues related to a travel itinerary of the user which includes a location of the user and a destination.

In one example of the acoustically enhanced version of the navigation instructions, the acoustically enhanced version of the navigation instructions includes acoustically cleaning the instructions. Acoustically cleaning can include removing environmental noise that may distort how the verbal communications are perceived.

In one embodiment a method according to the present disclosure can include, determining, using an AI enhanced device, when the user is at a location where auditory navigation cues or messages are used.

In one example the data update from the monitoring system can be from a transit system or transit monitoring software application.

In another embodiment, a method can further include reducing environmental noise from a location of the user. The reducing of the environmental noise can include the audio headphone suppressing the environmental noise.

In another embodiment a method can further include reducing environmental noise from a location of the user. The reducing of the environmental noise can include the AI enhanced device suppressing the environmental noise.

In another embodiment the method can further include replaying the instructions, in response to the AI enhanced device receiving a command from the user initiating the replaying of the instructions.

In another embodiment the method can further include receiving the data update from a travel or transit monitoring software application. The AI enhanced device can listen for the one or more keywords in the navigation instructions as an audio broadcast at a location of the user. The AI enhanced device can derive the one or more keywords from the data update. The detecting of the one or more keywords can include detecting the one or more keywords in the navigation instructions in the audio broadcast at the location of the user. The auditory enhanced version of the navigation instructions can include acoustically cleaning the instructions.

Referring to the figures, and for example, FIG. 2, the system 500 a computer 590 (or AI system) remote from the mobile device 120 can electronically communicate, in all or in part, with a control system computer 572 as part of a control system 570. The control system 570 can include the computer 572 having a computer readable storage medium 573 which can store one or more programs 574, and a processor 575 for executing program instructions. The control system 570 can include control software 578 for managing the one or more programs. The control system can also include a storage medium which can include registration and/or account data 582 and user profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include the computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

The control system can also communicate with a computer system 590 which can include a learning engine/module 592 and a knowledge corpus or database 596. The computer system 590 can also communicate with the mobile device 120. In another example, the computer system 590 can be all or part of the control system, or all or part of the mobile device 120. The depiction of the computer system 590 as well as the other components of the system 500 are shown as one example according to the present disclosure. One or more computer systems can communicate with a communications network 560, e.g., the Internet. For example, the computer 590, and the control system 570 can communicate with the communications network 560, and the mobile device 120 can communicate with a local communications network which can communicate with the communications network 560.

In another embodiment according to the present disclosure, a computer system for enhancement of auditory navigation instructions can include a processor set, a computer-readable storage medium, and program instructions stored on the computer-readable storage medium to cause the processor set to perform operations as follows. The computer system includes detecting and receiving, at an AI enhanced device which include GPS (Global Positioning System) location data, navigation instructions. The receiving of the navigation instructions either from auditory capture by the AI enhanced device of an announcement at a location, or a data update from a monitoring system electronically received by the AI enhanced device.

In another embodiment according to the present disclosure, a computer program product for enhancement of auditory navigation instructions includes a computer readable storage medium, and program instructions stored on the computer readable storage medium to perform operations as follows. The computer program product includes detecting and receiving, at an AI enhanced device which include GPS (Global Positioning System) location data, navigation instructions, the receiving of the navigation instructions either from auditory capture by the AI enhanced device of an announcement at a location, or a data update from a monitoring system electronically received by the AI enhanced device. The computer program product can include detecting, using the AI enhanced device, one or more keywords in the navigation instructions. The computer program product can include in response to the detecting of the one or more keywords by the AI enhanced device, the AI enhanced device outputting an auditory enhanced version of the navigation instructions to audio headphones of the user.

### Additional Embodiments and Examples

In one embodiment according to the present disclosure, a method for Artificial Intelligence (AI) enhancement of auditory navigation instructions can include receiving, at an AI device, data and instructions from a smartphone which include GPS location data. The method includes determining, using the AI device, when a user is at a location where auditory navigation cues or messages are used. The method includes detecting keywords, using the AI device, including navigation cues or messages being delivered from the smartphone using the smartphone audio output. The method includes in response to the detecting of the keywords by the AI device, the AI device outputting an enhanced and acoustically cleaned version of the navigations cues or messages to earbuds used by the user.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Referring to one or more embodiments in the figures, a computer or a device, also can be referred to as a user device or an administrator’s device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

It is understood that the user device is representative of similar devices which can be for other users, as representative of such devices, which can include, mobile devices, smart devices, laptop computers etc.

### Additional Examples and Embodiments

In one example, a system according to the present disclosure can include a control system communicating with a user device via a communications network. The control system can incorporate all or part of an application or software for implementing the method of the present disclosure. The control system can include a computer readable storage medium where account data and/or registration data can be stored. User profiles can be part of the account data and stored on the storage medium. The control system can include a computer having computer readable storage medium and software programs stored therein. A processor can be used to execute or implement the instructions of the software program. The control system can also include a database.

A control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

The program(s) can include all or in part, a series of executable steps for implementing the method of the present disclosure. A program, incorporating the present method, can be all or in part stored in the computer readable storage medium on the control system or, in all or in part, on a computer or device. It is envisioned that the control system can not only store the profile of users, but in one embodiment, can interact with a website for viewing on a display of a device such as a mobile device, or in another example the Internet, and receive user input related to the method and system of the present disclosure. It is understood that embodiments shown in the figures depicts one or more profiles, however, the method can include multiple profiles, users, registrations, etc. It is envisioned that a plurality of users or a group of users can register and provide profiles using the control system for use according to the method and system of the present disclosure.

### Still Further Embodiments and Examples

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register and have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user’s option to cancel such profile or account, and/or input of data, and thus opt-out, at the user’s discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user’s authorization and consent.

### Other Additional Embodiments and Examples

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

### More Examples and Embodiments

Additionally, methods and systems according to embodiments of the present disclosure can be discussed in relation to a functional system(s) depicted by functional block diagrams. The methods and systems can include components and operations for embodiments according to the present disclosure and is used herein for reference when describing the operational steps of the methods and systems of the present disclosure. Additionally, the functional system, according to an embodiment of the present disclosure, depicts functional operations indicative of the embodiments discussed herein.

The methods and systems of the present disclosure can include a series of operational blocks for implementing one or more embodiments according to the present disclosure. A method shown in the figures may be another example embodiment, which can include aspects/operations shown in another figure and discussed previously but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or ecosystems or environments, which can include, for example and artificial intelligence (AI) environment.

The descriptions of the various embodiments of the present invention have been presented for purposes of illustration but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein. In one example, the one or more computers can communicate with all or part of a computing environment and its components as a remote computer system to achieve computer functions described in the present disclosure.

### More Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

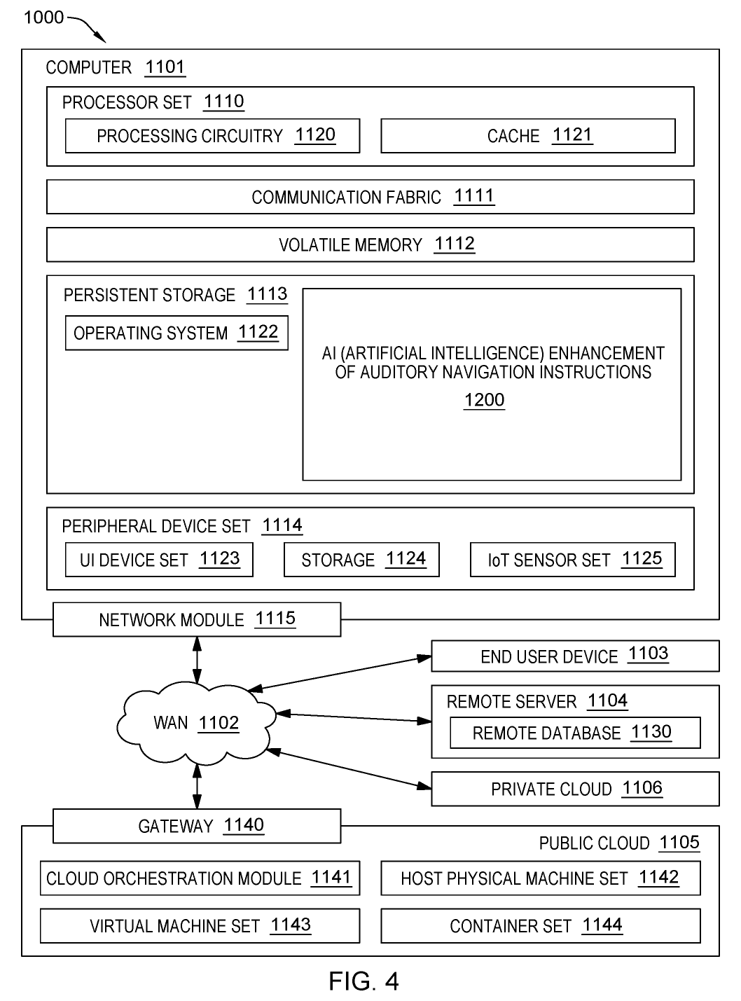

Referring to FIG. 4, a computing environment 1000 contains an example of an environment for the execution of at least some of the computer code involved in performing the inventive methods, such as using AI (Artificial Intelligence) enhancement of auditory navigation instructions 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1101, to keep the presentation as simple as possible. Computer 1101 may be located in a cloud, even though it is not shown in a cloud in the Figures. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1000, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A computer-implemented method for enhancement of auditory navigation instructions, comprising:
detecting and receiving, at an AI (Artificial Intelligence) enhanced device which includes GPS (Global Positioning System) location data, navigation instructions, the receiving of the navigation instructions either from auditory capture by the AI enhanced device of an announcement at a location, or a data update from a monitoring system electronically received by the AI enhanced device;
detecting, using the AI enhanced device, one or more keywords in the navigation instructions; and
in response to the detecting of the one or more keywords by the AI enhanced device, the AI enhanced device outputting an acoustically enhanced version of the navigation instructions to audio headphones of a user.

2. The method of claim 1, wherein the keywords include navigation cues for the user.

3. The method of claim 1, wherein the keywords include navigation cues related to a travel itinerary of the user which includes a location of the user and a destination.

4. The method of claim 1, wherein the enhanced version of the navigation instructions includes acoustically cleaning the instructions.

5. The method of claim 1, further comprising:
determining, using an AI enhanced device, when the user is at a location where auditory navigation cues or messages are used.

6. The method of claim 1, wherein the data update from the monitoring system is from a transit system or transit monitoring software application.

7. The method of claim 1, further comprising:
reducing environmental noise from a location of the user, the reducing of the environmental noise including the audio headphone suppressing the environmental noise.

8. The method of claim 1, further comprising:
reducing environmental noise from a location of the user, the reducing of the environmental noise including the AI enhanced device suppressing the environmental noise.

9. The method of claim 1, further comprising:
replaying the instructions, in response to the AI enhanced device receiving a command from the user initiating the replaying of the instructions.

10. The method of claim 1, further comprising:
receiving the data update from a travel or transit monitoring software application;
the AI enhanced device listening for the one or more keywords in the navigation instructions as an audio broadcast at a location of the user;
the AI enhanced device deriving the one or more keywords from the data update;
the detecting of the one or more keywords including detecting the one or more keywords in the navigation instructions in the audio broadcast at the location of the user; and
the auditory enhanced version of the navigation instructions including acoustically cleaning the instructions.

11. A computer system for enhancement of auditory navigation instructions, comprising:
a processor set, a computer-readable storage medium, and program instructions stored on the computer-readable storage medium to cause the processor set to perform operations comprising:
detecting and receiving, at an AI enhanced device which includes GPS (Global Positioning System) location data, navigation instructions, the receiving of the navigation instructions either from auditory capture by the AI enhanced device of an announcement at a location, or a data update from a monitoring system electronically received by the AI enhanced device;
detecting, using the AI enhanced device, one or more keywords in the navigation instructions; and
in response to the detecting of the one or more keywords by the AI enhanced device, the AI enhanced device outputting an acoustically enhanced version of the navigation instructions to audio headphones of the user.

12. The system of claim 11, wherein the keywords include navigation cues for the user.

13. The system of claim 11, wherein the keywords include navigation cues related to a travel itinerary of the user which includes a location of the user and a destination.

14. The system of claim 11, wherein the acoustically enhanced version of the navigation instructions includes acoustically cleaning the instructions.

15. The system of claim 11, further comprising:
determining, using an AI enhanced device, when the user is at a location where auditory navigation cues or messages are used.

16. The system of claim 11, wherein the data update from the monitoring system is from a transit system or transit monitoring software application.

17. The system of claim 11, further comprising:
reducing environmental noise from a location of the user, the reducing of the environmental noise including the audio headphone suppressing the environmental noise.

18. The system of claim 11, further comprising:
reducing environmental noise from a location of the user, the reducing of the environmental noise including the AI enhanced device suppressing the environmental noise.

19. The system of claim 11, further comprising:
replaying the instructions, in response to the AI enhanced device receiving a command from the user initiating the replaying of the instructions.

20. A computer program product for enhancement of auditory navigation instructions, comprising:
a computer readable storage medium; and
program instructions stored on the computer readable storage medium to perform operations comprising:
detecting and receiving, at an AI enhanced device which includes GPS (Global Positioning System) location data, navigation instructions, the receiving of the navigation instructions either from auditory capture by the AI enhanced device of an announcement at a location, or a data update from a monitoring system electronically received by the AI enhanced device;
detecting, using the AI enhanced device, one or more keywords in the navigation instructions; and
in response to the detecting of the one or more keywords by the AI enhanced device, the AI enhanced device outputting an auditory enhanced version of the navigation instructions to audio headphones of the user.
